(19) United States
(12) Patent Application Publication
(10) Pub. No.: US 2001/0036559 A1
(43) Pub. Date: Nov. 1, 2001

(54) Metal-plastic composite made from long-fiber-reinforced thermoplastics

(76) Inventors: Ulrich Haack, Alsbach (DE); Bernhard Pfeiffer, Wallbach (DE)

Correspondence Address: CONNOLLY & HUTZ, P.O. BOX 2207, Wilmington, DE, 19899, US

(21) Appl. No.: 09/761,313

(22) Filed: Jan. 17, 2001

(30) Foreign Application Priority Data
Jan. 21, 2000 (DE) 10002642.7-16

(51) Int. Cl. B32B 5/12

(52) U.S. Cl. 428/577; 428/113

(57) ABSTRACT

The invention relates to metal-plastic composites in which the coefficients of thermal expansion of the plastic structures used are similar to those of the metals used, and whose strengths and stiffnesses are superior to those of purely metallic structures.

The present invention relates to a component made from long-fiber-reinforced thermoplastics and characterized by bonding between metal structures and plastic structures. The advance of automization in motor vehicle assembly makes it necessary, or at least highly desirable, that assemblies of rigid and movable parts can, where possible, themselves be put together and tested for correct functioning prior to their actual final installation into the motor vehicle as it is produced.

Load-bearing structures used in vehicle construction and in industrial applications are usually composed of metals. In this connection it has been found that a considerable rise in stiffness and in strength can be brought about by using cross-ribbing, for example. A similar metal-plastic composite is described in EP 0 370 342 B1.

It is possible here to reduce the wall thickness for a given load, and thus to make a considerable saving in weight.

These load-bearing structures may serve as mounting supports (front end, door module, dashboard support). For this purpose, a high level of mechanical properties is required, and this level can be provided by metal-plastic composites. In addition, thermoplastically processable plastic gives the high degree of integration which allows low-cost design.

However, a disadvantage is that the coefficients of thermal expansion of the plastics used here differ from those of the metals. During processing, and during use in metal-plastic composites used over a wide temperature range, these differences cause internal stresses and distortion, which in turn reduce load-bearing capacity and accelerate material fatigue. These problems are indicated in lines 15-18, column 2 of EP 0 370 342 B1. The presence of the disadvantages described above could be deduced from the mention of the fact that the coefficient of thermal expansion of a metal-plastic composite is essentially determined by the metal.

DE 38 18 478 A1 describes a composite material comprising a metal layer and comprising a crosslinked polypropylene layer, fiber-reinforced with a glass fiber mat and having a coefficient of thermal expansion similar to that of the metal used. A disadvantage here is that injection molding is made difficult or impossible by the use of a glass fiber mat and by the crosslinking. The crosslinking also makes it impossible to recycle the plastic.

The object of the invention was to produce metal-plastic composites in which the coefficients of thermal expansion of the uncrosslinked plastic structures used are similar to those of the metals used, and whose strengths and stiffnesses are superior to those of purely metallic structures, while their weight is identical or lower.

Surprisingly, it has now been found that the coefficients of thermal expansion of long-fiber-reinforced thermoplastics are similar to those of steel, aluminum, and magnesium, and that the long-fiber-reinforced thermoplastics have less tendency to creep than short-fiber-reinforced thermoplastics. Using these materials it is possible to produce metal-plastic composites with strengths and stiffnesses superior to those given by purely metallic structures, and with weights below those of purely metallic structures.

The invention therefore provides a metal-plastic composite comprising at least one metal and comprising at least one long-fiber-reinforced thermoplastic whose coefficient of thermal expansion is similar to that of the metal used. The term long-fiber-reinforced thermoplastics is generally used for thermoplastics reinforced with fibers whose length is at least 0.5 mm and not more than 50 mm. The length of the fibers is preferably from 1 mm to 25 mm, in particular from 1 mm to 12 mm. The length of the pellets and the length of the fibers are mostly identical in these materials. The reinforcing fiber is not restricted to a particular material. It is preferable here to use fibers made from materials with high melting points, for example glass fibers, carbon fibers, metal fibers, or aromatic polyamide fibers. The fibers within the pellets here may have been completely impregnated with the thermoplastic, or be in the form of a glass-fiber bundle coated by plastic.

Ribs made from material such as polypropylene are injected into metallic structures. Polypropylene was selected as the lowest- density plastic. The use of long fibers as reinforcing material allows coefficients of thermal expansion similar to those of metals, and low tendency to creep, to be achieved without any need to crosslink the thermoplastic used.

The mechanical properties of the long-fiber-reinforced thermoplastic are markedly superior to those given by short-fiber-reinforced thermoplastics.

Use of long-fiber-reinforced thermoplastics allows dramatic rises in strength and in stiffness to be achieved, together with a low tendency to creep and a coefficient of thermal expansion similar to that of metals.

The loading placed on the metal-plastic bonds in the metal-plastic composites described was so high that here again the advantages in strength and in stiffness over short-glass-fiber-reinforced thermoplastics were required in order to produce a component which could be subjected to high load.

The component according to the invention may generally be composed of metal structures of any desired metals, and is advantageously composed of iron or steel (including high-alloy or stainless), aluminum, magnesium or titanium.

To improve adhesion, the surface may advantageously have been provided with adhesion promoters, primers or surface coatings.

According to the invention, plastic materials which may be used are long-glass-fiber-reinforced or carbon-fiber-reinforced thermoplastics based on polyethylene, polypropylene, polyacetal, polyamide, polyester, polyphenylene oxide, polyphenylene sulfide, polyurethane, polycarbonate or polyester or acrylonitrile-butadiene-styrene copolymers or on acrylonitrile-styrene-acrylate graft polymers, or blends made from the plastics mentioned. Particular polyesters which may be used are polyethylene terephthalate or polybutylene terephthalate.

Plastic materials which may be used, besides freshly produced materials, are first-, second- or higher-generation recycled materials, or mixtures made from freshly produced material with recycled materials. Mixtures of this type may, if desired, also comprise additives, or may have been modified by admixture of other compatible polymers. There is no need for crosslinkers to be added in order to achieve the advantages of the invention.

Besides the long reinforcing fibers, the plastic material may also comprise other conventional additives and reinforcing materials, for example other fibers, in particular metal fibers, or mineral fibers, processing aids, polymeric lubricants, ultra high-molecular-weight polyethylene (UHMWPE), polytetrafluoroethylene (PTFE), or graft copolymer, which is a product from a graft reaction, made from an olefin polymer and from an acrylonitrile-styrene copolymer, antioxidants, adhesion promoters, nucleating agents, mold-release aids, glass beads, mineral fillers, such as chalk, calcium carbonate, wollastonite, silicon dioxide, talc, mica, montmorillonite, organically modified or unmodified, organically modified or unmodified phyllosilicates, materials which form nanocomposites with the plastic, nylon nanocomposites, or mixtures of the substances mentioned.

The coefficient of thermal expansion is similar to that of a metal if it does not deviate by more than 20×10⁻⁶K⁻¹ from the coefficient of thermal expansion of the metal used.

The plastic structures may be produced by thermoplastic processing methods, preferably by conventional techniques, such as injection molding, thermoforming, hot-press molding, injection-compression molding, low-pressure injection molding or blow molding.

The cross section of the metal structures preferably has the shape of a U, V or W. Within these metal structures, the shapes of the plastics may be as desired, extending to sheet-like layers, and the plastics may have been provided with functional parts, such as housings or housing sections, snap connectors or film hinges. Since abrasion performance with respect to plastic and metal is good, the functional parts may advantageously be sliding surfaces. These plastic structures preferably have the shape of ribs.

According to the invention, there are two different ways of producing the metal-plastic bonding. The first method uses one of the thermoplastic processing methods to bring about bonding within the metal structure.

The bonding is preferably produced by interlocking, under- cutting (e.g. by using a dovetail shape) or penetration through an aperture or slot, where a plug is produced on the reverse side of the aperture and cannot be pulled back through the aperture without being destroyed. In the second possibility, the metal-plastic bonding is brought about by introducing elevations of peg-like or other shape on the plastic part into openings in the metal structure, for example apertures or slots. A permanent connection is produced advantageously by subsequent heat welding, bending or thermal deformation.

The coefficients of thermal expansion of long-glass-fiber reinforced thermoplastics are similar to those of steel, aluminum and magnesium (Table 1).

| Material | Coefficient of thermal |
|---|---|
| (Plastic-Fiber, Amount of | expansion |
| fiber/weight %) | 10⁻⁶ K⁻¹ |
| PP-GF 30 | 16 |
| PP-GF 40 | 15 |
| PP-GF 50 | 13 |
| PA66-GF 40 | 19 |
| PA66-GF 50 | 17 |
| PA6G-GF 60 | 15 |
| PA66-CF 40 | 13 |
| PET-GF 40 | 16 |
| PBT-GF 40 | 19 |
| PPS-GF 50 | 12 |
| PC/ABS-GF 40 | 18 |
| TPU-GF 40 | 13 |
| TPU-GF 50 | 10 |
| TPU-CF 40 | 18 |
| Comparison with metals | |
| Iron | 12.2 |
| Steel | 12 |
| Magnesium | 26 |
| Aluminum | 22 |
| Comparison with | |
| unreinforced plastics | |
| Unreinforced PP | 83 |
| Unreinforced PA66 | 90 |

Table. 1: Coefficients of thermal expansion of long-fiber-reinforced thermoplastics (from −30° C. to +30° C.); PP-polypropylene, PA-polyamide, PET-polyethylene terephthalate, PBT-polybutylene terephthalate, PPS-polyphenylene sulfide, PC/ABS-polycarbonate-ABS-blend, TPU-thermoplastic polyurethane elastomer, GF-glass fiber, cf-carbon fiber

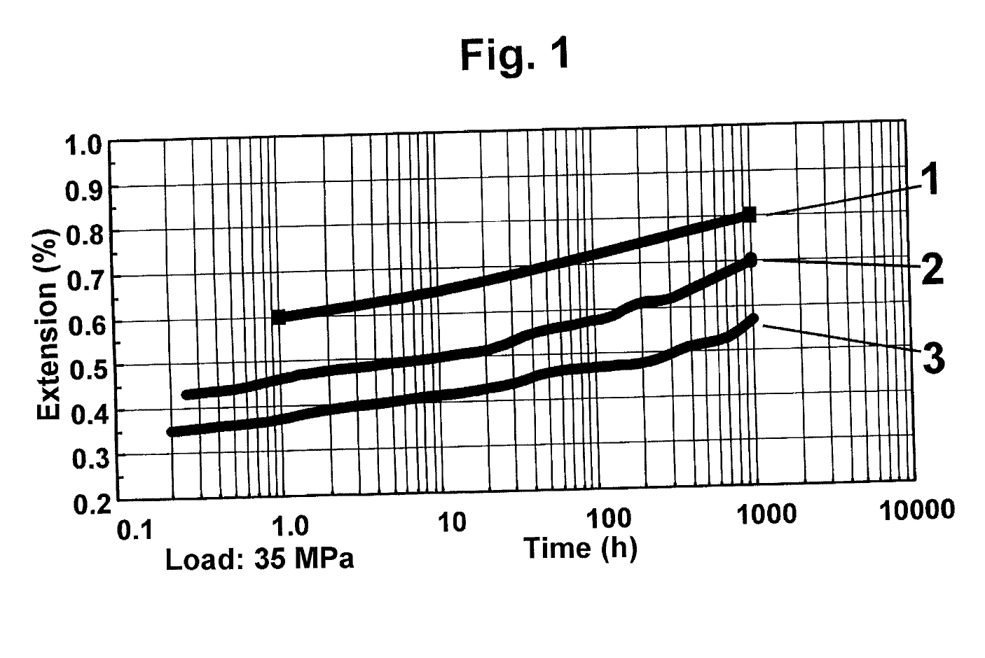

Long-fiber-reinforced thermoplastics also have a lower tendency to creep than short-fiber-reinforced thermoplastics. The invention is further illustrated by FIG. 1. FIG. 1 plots the percentage elongation against load duration. Curve 1 shows the creep performance of a short-glass-fiber-reinforced nylon-6,6 with a proportion of 30% of glass fibers, and curves 2 and 3 show the creep performance of long-glass-fiber-reinforced polypropylene with a proportion of 40% and 50% of glass fibers.

The creep performance and coefficients of thermal expansion of long-glass-fiber-reinforced thermoplastics make them particularly suitable for use in metal-plastic composites used over a wide temperature range, as is the case in the automotive industry, for example (from −40 to +120° C.).

1. A metal-plastic composite comprising at least one metal and comprising at least one uncrosslinked long-fiber-reinforced thermoplastic whose coefficient of thermal expansion is similar to that of the metal used.

2. The metal-plastic composite as claimed in claim 1, where the plastic used comprises polyethylene, polypropylene, polyamide, polyacetal, polyester, polyphenylene oxide, polyphenylene sulfide, polyurethane, polycarbonate, polyester, acrylonitrile-butadiene-styrene copolymers or acrylonitrile-styrene-acrylate graft polymers, polyethylene terephthalate or polybutylene terephthalate, or comprising a mixture made from at least two of these plastics.

3. The metal-plastic composite as claimed in claim 1, where the fibers present in the plastic comprise glass fibers, carbon fibers, metal fibers or aromatic polyamide fibers.

4. The metal-plastic composite as claimed in claim 1, where the length of the polymer pellets used for the production process and the length of the reinforcing fiber are identical.

5. The metal-plastic composite as claimed in claim 1, obtainable by conventional thermoplastic processing methods, such as injection molding, thermoforming, hot-press molding, injection-compression molding, low-pressure injection molding or blow molding.

6. The metal-plastic composite as claimed in claim 1, where the metal used comprises iron, steel, aluminum, magnesium, or titanium.

7. A process for producing a metal-plastic composite as claimed in claim 1, in which the coefficient of thermal expansion of the plastic is similar to that of the metal used, the plastic used being a thermoplastic reinforced with fibers of length from 0.5 mm to 50 mm.

8. The use of the metal-plastic composite as claimed in claim 1, for producing load-bearing structures in front ends, in door modules, in dashboard supports, or in other mounting supports.
